(19) United States
(12) Patent Application Publication
(10) Pub. No.: US 2010/0066587 A1
(43) Pub. Date: Mar. 18, 2010

(54) Method and System for Controlling a Remote Vehicle

(76) Inventors: Brian Masao Yamauchi, Boston, MA (US); Christopher Vernon Jones, Woburn, MA (US); Scott Raymond Lenser, Waltham, MA (US)

Correspondence Address: O'Brien Jones, PLLC (w/iRobot Corp.), 8200 Greensboro Drive, Suite 1020A, McLean, VA, 22102, US

(21) Appl. No.: 12/560,410

(22) Filed: Sep. 15, 2009

Related U.S. Application Data
(63) Continuation-in-part of application No. 11/826,541, filed on Jul. 16, 2007.
Application No. 11/826,541 is a continuation-in-part of application No. 11/618,742, filed on Dec. 30, 2006, now Pat. No. 7,539,557.
(60) Provisional application No. 60/807,434, filed on Jul. 14, 2006.
(60) Provisional application No. 60/871,771, filed on Dec. 22, 2006.
(60) Provisional application No. 60/822,176, filed on Aug. 11, 2006.

(51) Int. Cl. G01S 13/00

(52) U.S. Cl. 342/70; 342/54

(57) ABSTRACT

A system for controlling a remote vehicle comprises: a LIDAR sensor, a stereo vision camera, and a UWB radar sensor; a sensory processor configured to process data from one or more of the LIDAR sensor, the stereo vision camera, and the UWB radar sensor; and a remote vehicle primary processor configured to receive data from the sensory processor and utilize the data to perform an obstacle avoidance behavior.

### INTRODUCTION

This is a continuation-in-part of U.S. patent application Ser. No. 11/826,541, filed Jul. 16, 2007. U.S. patent application Ser. No. 11/826,541 is a continuation-in-part of U.S. patent application Ser. No. 11/618,742, filed Dec. 30, 2006, entitled Autonomous Mobile Robot. U.S. patent application Ser. No. 11/826,541 claims priority to U.S. Provisional Patent Application No. 60/807,434, filed Jul. 14, 2006, entitled Mobile Robot, Robotic System, and Robot Control Method, U.S. Provisional Patent Application No. 60/871,771, filed Dec. 22, 2006, entitled System for Command and Control of Small Teleoperated Robots, and U.S. Provisional Patent Application No. 60/822,176, filed Aug. 11, 2006, entitled Ground Vehicle Control. The entire contents of the above-listed patent applications are incorporated by reference herein.

### BACKGROUND

Autonomous remote vehicles, such as man-portable robots, have the potential for providing a wide range of new capabilities for military and civilian applications. Previous research in autonomy for remote vehicles has focused on vision, a range finding system such as a light detection and ranging (LIDAR) system, and sonar sensors. While vision and LIDAR work well in clear weather, they can be impaired by rain, snow, fog, smoke, and, for example foliage. Foliage is often passable by a remote vehicle, yet LIDAR and vision may not be able to differentiate it from impassable obstacles. Sonar can penetrate adverse weather, but has a limited range outdoors, and suffers from specular reflections indoors.

Remote vehicles, such as small unmanned ground vehicles (UGVs), have revolutionized the way in which improvised explosive devices (IEDs) are disarmed by explosive ordnance disposal (EOD) technicians. The Future Combat Systems (FCS) Small Unmanned Ground Vehicle (SUGV) developed by iRobot® can provide remote reconnaissance capabilities, for example to infantry forces.

Existing deployed small UGVs are teleoperated by a remote operator who must control all of the remote vehicle's actions via a video link. This requires the operator's full attention and prevents the operator from conducting other tasks. Another soldier may be required to protect the operator from any threats in the vicinity.

It is therefore desirable to enable remote vehicles to navigate autonomously, allowing the operator to direct the remote vehicle using high-level commands (e.g., “Navigate to location X”) and freeing the operator to conduct other tasks. Autonomous navigation can facilitate force multiplication, i.e., allowing one operator to control many robots.

Previous research has been conducted in remote vehicle navigation, including some work with man-portable robots. These robots typically use sensors such as vision, LIDAR, and sonar to perceive the world and avoid collisions. While vision and LIDAR work well in clear weather, they can have limitations when dealing with rain and snow, and they are unable to see through thick smoke or fog. Sonar is able to operate in adverse weather and penetrate smoke and fog. However, sonar has limited range when used in the relatively sparse medium of air (as opposed to the dense medium of water). In addition, when a sonar pulse hits a flat surface, such as building wall, at a shallow angle, it often reflects away from the sensor (i.e. specular reflection) and the resulting range reading can be erroneously long or completely missing.

### SUMMARY

The present teachings provide a system for controlling a remote vehicle comprises: a LIDAR sensor, a stereo vision camera, and a UWB radar sensor; a sensory processor configured to process data from one or more of the LIDAR sensor, the stereo vision camera, and the UWB radar sensor; and a remote vehicle primary processor configured to receive data from the sensory processor and utilize the data to perform an obstacle avoidance behavior.

The present teachings also provide a system for allowing a remote vehicle to discern solid impassable objects from rain, snow, fog, and smoke for the purposes of performing an obstacle avoidance behavior. The system comprises: a LIDAR sensor, a stereo vision camera, a UWB radar sensor, and a GPS; a sensory processor configured to process data from one or more of the LIDAR sensor, the stereo vision camera, the UWB radar sensor, and the GPS; and a remote vehicle primary processor configured to receive data from the sensory processor and utilize the data to perform the obstacle avoidance behavior. Data from the UWB radar sensor is integrated with data from the LIDAR sensor to yield data for the obstacle avoidance behavior that represents solid impassable objects rather than rain, snow, fog, and smoke.

The present teachings further provide a method for allowing a remote vehicle to discern solid impassable objects from rain, snow, fog, and smoke for the purposes of performing an obstacle avoidance behavior. The method comprises integrating data from a LIDAR sensor with data from a UWB radar sensor to yield data for the obstacle avoidance behavior that represents solid impassable objects rather than rain, snow, fog, and smoke.

Additional objects and advantages of the present teachings will be set forth in part in the description which follows, and in part will be obvious from the description, or may be learned by practice of the teachings. The objects and advantages of the present teachings will be realized and attained by means of the elements and combinations particularly pointed out in the appended claims.

It is to be understood that both the foregoing general description and the following detailed description are exemplary and explanatory only and are not restrictive of the present teachings, as claimed.

The accompanying drawings, which are incorporated in and constitute a part of this specification, illustrate exemplary embodiments of the present teachings and, together with the description, serve to explain the principles of those teachings.

### BRIEF DESCRIPTION OF THE DRAWINGS

FIG. 1 illustrates an exemplary overhead view of a UWB radar scan.

FIG. 2A illustrates an exemplary UWB radar-equipped remote vehicle in proximity to the chain link fence and building structure.

FIG. 2B shows DFA-filtered data from the environment show in FIG. 2A.

FIG. 3 illustrates results from an indoor experiment using UWB radar mounted on a remote vehicle.

FIG. 4 illustrates an exemplary embodiment of a UWB radar and pan/tilt mounted via a mast to a remote vehicle.

FIG. 5A shows a remote vehicle equipped with UWB radar in a fog-free environment.

FIG. 5B shows data from the environment surrounding the remote vehicle in FIG. 5A.

FIG. 6A shows a remote vehicle equipped with UWB radar in a moderate fog environment.

FIG. 6B shows data from the environment surrounding the remote vehicle in FIG. 6A.

FIG. 7A shows a remote vehicle equipped with UWB radar in a dense fog environment.

FIG. 7B shows data from the environment surrounding the remote vehicle in FIG. 7A.

FIG. 8 illustrates another exemplary embodiment of a UWB radar and pan/tilt mounted to a remote vehicle.

FIG. 9 illustrates an exemplary baseline software design in accordance with the present teachings.

FIG. 10 illustrates an exemplary complete software design in accordance with the present teachings.

FIG. 11 illustrates an exemplary embodiment of an operator control unit for controlling a remote vehicle in accordance with the present teachings.

FIG. 12 illustrates another exemplary embodiment of an OCU for use with the present teachings.

FIG. 13 illustrates an exemplary embodiment of a computer hardware organization for a remote vehicle.

FIG. 14 illustrates an exemplary embodiment of a data flow among system components segregated into functional groups.

### DESCRIPTION

Reference will now be made in detail to exemplary embodiments of the present teachings, examples of which are illustrated in the accompanying drawings. Wherever possible, the same reference numbers will be used throughout the drawings to refer to the same or like parts.

Radar can offer the capability to detect obstacles through rain, snow, and fog without the above-described limitations of sonar. Radar-based Adaptive Cruise Control (ACC) and active brake assist systems are presently available for certain luxury automobiles. Such ACC systems typically monitor the range to the vehicle ahead and adjust the throttle to maintain a constant following distance, while active brake assist systems typically provide additional braking force if a collision is imminent.

The present teachings include using a sensor suite including ultra-wide band (UWB) radar to provide all-weather perception capabilities for remote vehicles such as, for example, a man-portable iRobot® PackBot® UGV. Unlike conventional radar, which transmits relatively long pulses of radio frequency (RF) energy within a narrow frequency range, UWB radar sends a short pulse of RF energy across a wide range of frequencies. The brief duration of each pulse results in improved range resolution compared with conventional radar, combined with an immunity to passive interference (e.g., rain, fog, aerosols), and the ability to detect targets that are stationary with respect to the UWB radar sensor.

Radar used for automotive cruise control and braking can differ in several fundamental ways from UWB radar. For example, radar used for automotive applications is typically optimized for detecting obstacles at long range (e.g., up to 200 meters) with a typical range resolution of about 1 meter and a typical range accuracy of about 5%. In general, automotive radars return multiple tracks for the strongest targets; however, they are typically unable to detect the difference between small objects (e.g., a metal bolt or a sewer grate) and large objects (e.g., cars). Thus, radar is used in automotive application primarily to detect moving objects, since any object moving at high speeds can be assumed to be another vehicle.

In contrast to radar known for use in automotive applications, UWB radar, for example Multispectral Solutions (MSSI) Radar Developer's Kit Lite (RaDeKL) UWB radar, can provide precise ranging at short to medium range, for example providing about a 0.3 meter (1 foot) resolution at ranges of up to about 78 meters (256 foot). Instead of providing processed radar tracks, UWB radar can provide raw radar strength measured in each 0.3 meter wide range bin, and include, for example, 256 range bins. As a result, the radar return can be used to measure the size and shape of obstacles rather than just their presence. In addition, UWB radar is suitable for use indoors as well as outdoors.

The Multispectral Solutions (MSSI) RaDeKL UWB radar can comprise two sonar transducers that transmit and receive UWB radar pulses at, for example, about 6.35 GHz. UWB radar can have a 40° (horizontal)×40° (vertical) field of view, a maximum range of 255 feet, and a range resolution of 1 foot. UWB radar can typically detect a human at ranges of up to 90 feet.

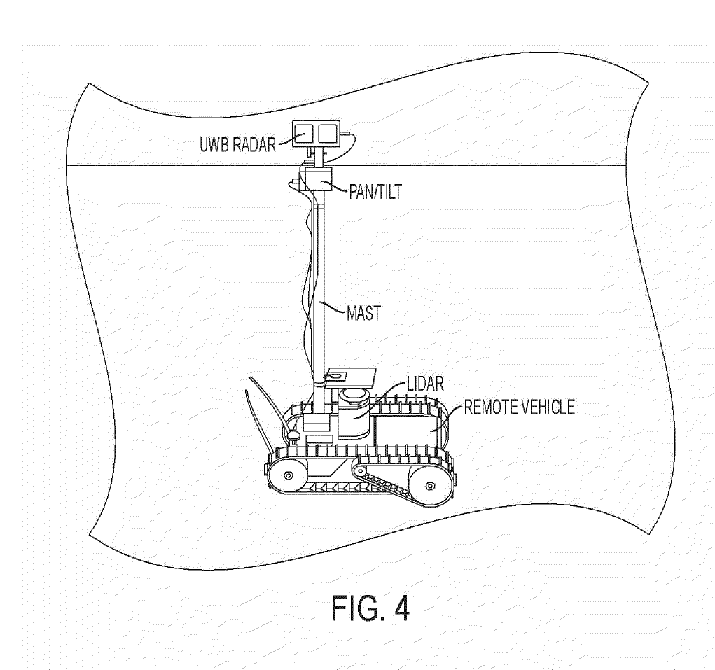

Because the UWB radar can be limited to a 40° field-of-view, the UWB radar can, in accordance with certain embodiments, be scanned to build a complete map of an immediate environment of the remote vehicle. For this reason, the UWB radar can be mounted on a pan/tilt as shown in FIG. 4.

The present teachings contemplate using alternatives to the MSSI RaDeKL, such as, for example, a frequency modulated continuous wave (FMCW) millimeter wave radar sensor, a Time Domain® Corporation RadarVision® sensor as described in U.S. Pat. No. 7,030,806, a Zebra Enterprise Solutions Sapphire Ultra-Wideband (UWB) sensor.

In an exemplary embodiment of the present teachings, a RaDeKL UWB radar is mounted onto an iRobot® PackBot® via a pan/tilt base, such as a Biclops PT manufactured by TRACLabs. The pan/tilt unit can, for example, provide 360° coverage along the pan axis (+/−180°) and 180° range of motion along the tilt axis (+/−90°.) The angular resolution of the pan/tilt encoders can be, for example, 1.08 arc-minutes (20,000 counts/revolution). The pan/tilt unit can require a 24 V power supply at 1 Amps and can be controlled, for example, via a USB interface. Power for both the UWB radar and the pan/tilt base can be provided, for example, by the PackBot®'s onboard power system. The Biclops PT can pan and tilt at speeds of up to 170 degrees per second and accelerations of up to 3000 degrees per second squared.

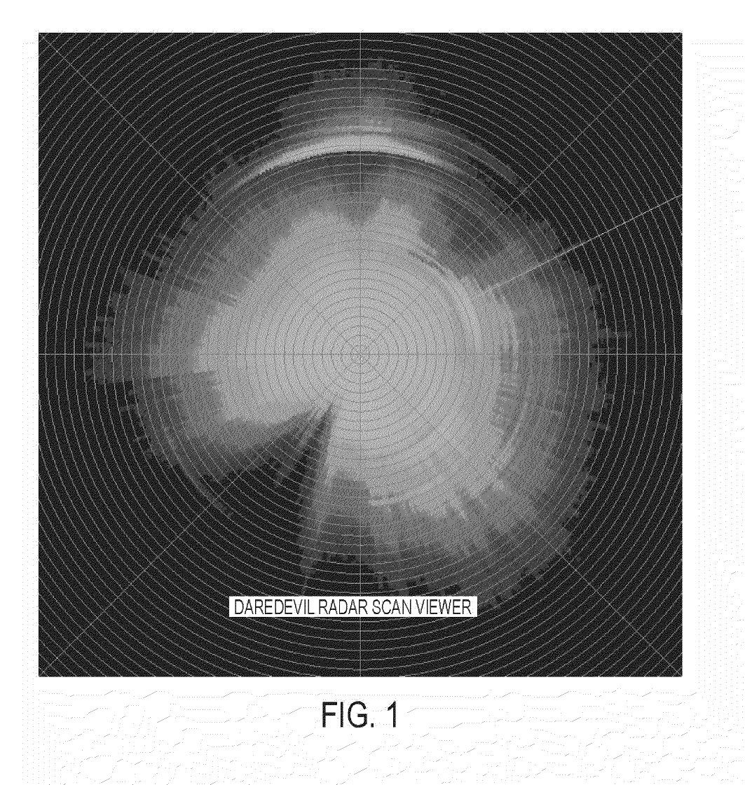

Certain embodiments of the present teachings contemplate providing a real-time viewer for the scanning UWB radar mounted on the pan/tilt mount. FIG. 1 illustrates an exemplary overhead view of a UWB radar scan output. In this image, brighter areas correspond to stronger returns. The radar is located at the center of the image, and the concentric circles can be spaced, for example, at 1 m intervals. The radially-extending bright line indicates the current bearing of the UWB radar. The bright arc at the top represents, for example, a concrete wall. The bright area on the top right of the image represents, for example, a shipping container.

In use, in accordance with certain embodiments of the present teachings, the UWB radar can be rotated 360° (panning left and right) at a speed of about 0.1 radians/second. Full power (−0 dB) can be used for the UWB radar transmitter, while the UWB radar receiver can be attenuated by −20 dB, for example, to reduce noise.

In accordance with certain embodiments, UWB radar readings can be received from the UWB radar at an average rate of about 10 Hz, so that the average angular separation between readings can be roughly 0.5°. Each reading can comprise a return strength for the 256 range bins (each being 0.3 meters long) along a current bearing of the UWB radar. For each bin, a square area can be drawn at a corresponding viewer location, with a brightness of the area corresponding to a strength of the UWB radar return. Unlike a grid representation, the (x, y) center of each region of the viewer is not quantized, since the current UWB radar bearing is a continuous floating-point value.

The large area of strong returns in FIG. 1 near the UWB radar (at center) can be due to reflections from ground clutter. In an experiment yielding the viewer results illustrated in FIG. 1, the UWB radar mounted on the pan/tilt base detected some obstacles reliably (e.g., a wall and a shipping container), but also displayed brightness from a large amount of energy being returned to the UWB radar from ground clutter close to the radar. The readings in FIG. 1 represent use of the UWB radar in an open parking lot, with the UWB radar mounted about 1 meter above the ground, oriented parallel to the ground, and horizontally polarized. It thus may be desirable to provide filtering of, for example ground clutter, to facilitate more accurate interpretation of the UWB radar data.

The present teachings contemplate providing such a filter. One such filter is referred to herein as a delta filter algorithm (DFA) and can reduce the effects of ground clutter and better identify true obstacles in UWB radar data. In accordance with certain embodiments, the DFA examines radar return bins in order from the UWB radar outward. If the UWB radar reading for the current bin exceeds the reading from the previously examined bin by greater than a threshold value δ, the bin location is marked as occupied. Otherwise, the bin location is marked as empty

If rawᵢ is the value of bin i, then the corresponding DFA value is given by equation (1):

$${delta}_{i} = \{ \begin{matrix}1 & if {raw}_{i} - {raw}_{i - 1} > δ \\ 0 & otherwise\end{matrix} \qquad ( 1 )$$

By applying the DFA to UWB radar data, more accurate range readings can be obtained from the UWB radar.

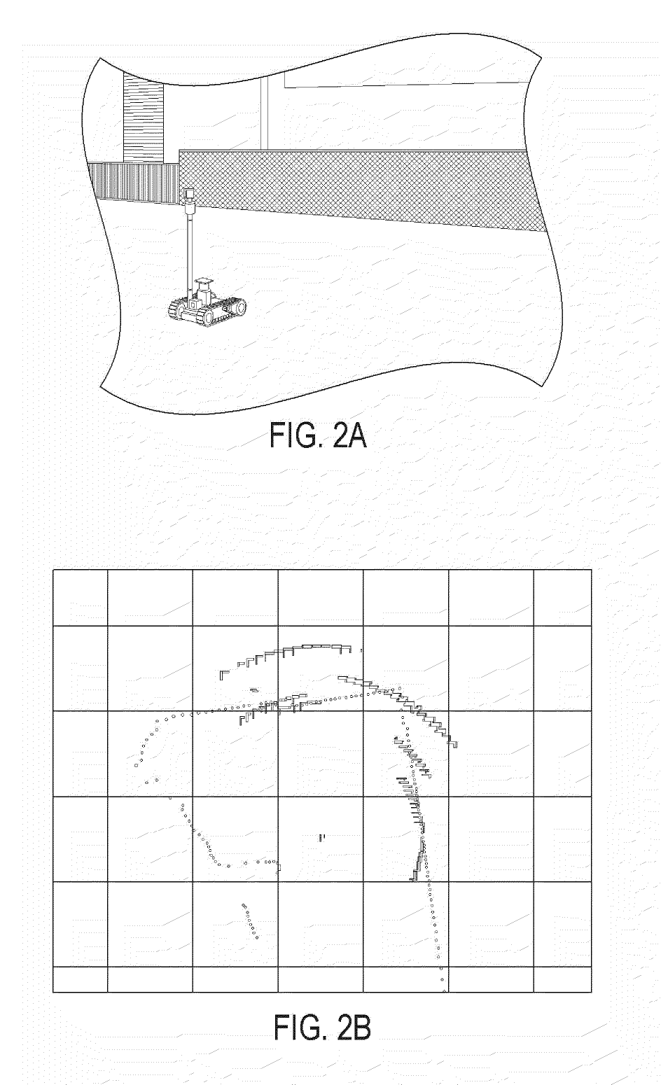

In addition to providing reliable obstacle detection in rain, snow, fog, and smoke, UWB radar can see through structures such as fences and detect obstacles behind the fences and, for example, certain types of foliage—such as tall grass, open fields, and crop fields. FIG. 2B illustrates detection beyond a chain link fence with white plastic slats forming an opaque barrier. FIG. 2A illustrates an exemplary UWB radar-equipped host iRobot® PackBot® in proximity to the chain link fence and building structure. FIG. 2B shows DFA-filtered data from the environment of FIG. 2A, with UWB radar data being represented by the green (dashed) lines and LIDAR data from the same environment surrounding the host iRobot® PackBot® being represented by the red (dotted) lines. The data shown in FIG. 2B was obtained with the delta threshold set to 1 (δ=1), transmit attenuation set to −5 dB, and receiver sensitivity set to maximum (0 dB). Grid lines are spaced at 10 m intervals. The apparent stair-stepping is an artifact of the way this image was rendered, with overlapping squares for the radar points. The actual range data shows smooth arcs.

At longer ranges, reflections from the concrete wall are represented by arcs rather than straight lines. This is due to a large, for example a 40° horizontal field of view, of the UWB radar and the fact that only one sensor value is returned per range bin across the field of view. The arcing effect can be reduced in one or more of the following three ways.

First, data can be accumulated from multiple remote vehicle positions in an occupancy grid map, described in more detail below, to reinforce the occupancy probability of cells corresponding to real obstacles while reducing the occupancy probability of cells along each arc that do not correspond to real obstacles. This is because as the remote vehicle moves, the arcs shift (remaining centered on the current remote vehicle location), and the only points that remain constant are those corresponding to real obstacles.

Second, the UWB radar sensor model can be extended from a point model, which increases the occupancy of the cell at the center of each range bin, to an arc model that increases the occupancy for all cells along the range arc. This can allow multiple readings from a single robot position (but multiple sensor angles) to reinforce the points corresponding to actual obstacles, while reducing other points.

Third, knowledge of the UWB radar's lateral scan behavior can be used to detect when an obstacle enters or exits the UWB radar's current field of view. When a range bin increases, the increase generally indicates a new obstacle detected at a leading edge of the UWB radar's sensor field of view. When a range bin decreases, the decrease generally indicates that a center of the field of view passed the obstacle about one half a field-of-view width previously. However, this only applies in situations where the environment is static and the remote vehicle is stationary.

In accordance with the present teachings, an alternative or additional filtering algorithm can be provided and is referred to herein as a max filter algorithm (MFA). The MFA examines all of the UWB radar bins in a given return and returns a positive reading for the bin with the maximum return strength, if that bin is farther than a minimum range threshold. If the maximum return strength is for a bin that is closer than the minimum range threshold, the filter returns a null reading. If more than one reading has the maximum value, the MFA returns the closest reading if the range to the closest reading is over the minimum range threshold, and a null reading otherwise.

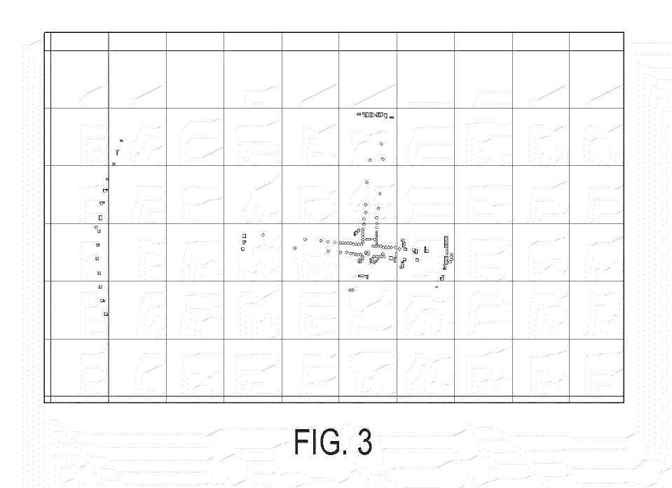

The MFA provides a very effective method for finding the strongest radar reflectors in an environment with many reflections. FIG. 3 illustrates results from an indoor experiment using the MFA with UWB radar mounted on a host iRobot® PackBot®, the UWB radar scanning 360° from a fixed location at a center of a hallway intersection. In FIG. 3, MFA-filtered data from the environment surrounding the host iRobot® PackBot® is represented by the green (dashed) lines and LIDAR data from the same environment surrounding the host iRobot® PackBot® is represented by the red (dotted) lines. The grid lines are spaced at 10-meter intervals.

As can be seen in FIG. 3, the UWB radar with MFA filtering can detect closed doors at the ends of the hallways at ranges of, for example, up to 45 meters. In the case of the left door, LIDAR only provided a single return, while the UWB radar provided multiple returns. FIG. 3 also illustrates, however, a relatively low angular resolution of the UWB radar sensor. The present teachings contemplate utilizing occupancy grids as described hereinbelow to accumulate UWB radar data over multiple returns and provide a more precise estimation of target location based on probabilistic sensor models.

An accordance with the present teachings, an alternative or additional filtering algorithm can be provided and is referred to herein as a calibrated max filter algorithm (CMFA), which is a modified version of the MFA described above. The CMFA can eliminate ambient reflections from a ground plane, which typically are stronger close to the UWB radar and weaker farther from the UWB radar. In the MFA, the minimum detection range is set farther from the UWB radar to ignore reflections from ground clutter, which can prevent the MFA from detecting close-range obstacles. The CMFA can detect closer objects by subtracting an ambient reflection's signal (i.e., the reflection with no obstacle present) from a signal representing the total reflection. Any remaining signal above the ambient reflection's signal indicates the presence of an obstacle.

In a calibration stage of the CMFA, the UWB radar is first aimed at open space in a current environment. A series of raw UWB radar readings is returned and an average value of each bin is stored in a calibration vector as set forth in equation (2):

$${c}_{i} = \frac{1}{n} {\sum }_{i = 1 … n} {r}_{j , i} \qquad ( 2 )$$

In equation (2), cᵢ is element i of the calibration vector, r_{j,i} is bin i from raw radar scan j, and n is the number of raw range scans stored. In an exemplary implementation multiple, for example over twenty, raw radar scans can be averaged to account for noise.

During operation of the remote vehicle, the calibration vector is subtracted from each raw range scan and the result is stored in an adjusted range vector (3) as follows:

$${a}_{i} = \{ \begin{matrix}0 & if {r}_{i} < {c}_{i} \\ {r}_{i} - {c}_{i} & otherwise\end{matrix} \qquad ( 3 )$$

where aᵢ is element i of the adjusted range vector, rᵢ is bin i of the raw range vector, and cᵢ is element i of the calibration vector.

The MFA can then be applied to the adjusted range vector (3) to determine a filtered range value. An index of a maximum element of the adjusted range vector (3) is returned. If more than one element has the maximum value, the index of the bin closest to the sensor is returned in accordance with equation (4) below:

$${r}_{CMFA} = \{ \begin{matrix}null & if ∀ i : {a}_{i} = 0 \\ i & if ∀ j , i \neq j : {a}_{i} \geq {a}_{j} and ∀ j , i \neq j , {a}_{i} = {a}_{j} : i < j\end{matrix} \qquad ( 4 )$$

An accordance with the present teachings, an alternative or additional filtering algorithm can be provided and is referred to herein as a radial filter algorithm (RFA). The RFA is designed for use with a scanning UWB radar sensor and works by taking an average range bin value of each of the existing range bins and subtracting the mean value from the score. If raw_{i,t} is the raw radar reading for bin i at time t, then avg_{i,t} is a decaying exponential average of recent values, which is computed as follows:

avg_{i,t}=(1−λ)avg_{i,t-1}+λraw_{i,t} (5)

where λ is a learning rate constant between 0.0 and 1.0. A learning rate of 0.0 means that the these values will never change, while a learning rate of 1.0 means that no history is kept and the current radar values are passed directly to the RFA. A learning rate of 0.01 can work well for a scan rate of about 90° per second and a UWB radar update rate of about 10 Hz.

As the UWB radar is scanned through a 360° arc, each element of the average value vector will represent the average radar value at the corresponding range in all directions. For example, avg_{10,t} is the average of all radar bin values, in all directions, at a range of 10 feet at time t. These values can then be subtracted from the current raw radar values to compute the current filtered radar values:

$${filter}_{i , t} = \{ \begin{matrix}{raw}_{i , t} - {avg}_{i , t} & if {raw}_{i , t} > {avg}_{i , t} \\ 0 & otherwise\end{matrix} \qquad ( 6 )$$

Other than the DFA, MFA, CMFA, and RFA filters discussed above, the present teachings contemplate utilizing the following additional or alternative methods for removing or avoiding reflections from ground clutter: (1) tilting the UWB radar sensor up at a 40° angle to reduce the energy being directed at the ground; (2) orienting the UWB radar sensor vertically, so that the radar signal will be vertically polarized to reduce the energy returned by the ground; (3) modeling the amount of energy expected to be returned from the ground at different ranges from the sensor, and subtracting this value from the corresponding range bin; and (4) detecting discontinuities in the radar data that indicate stronger returns from obstacles.

In certain embodiments, the UWB radar can be raised to avoid or lessen ground reflections that interfere with other UWB radar returns. A radar mounting post or mast can be provided that can be, for example, about 1 meter high. The UWB radar and the pan/tilt mount can be mounted on top of the post. An exemplary embodiment of the present teachings having a UWB radar and pan/tilt mounted on a mast is illustrated in FIG. 4.

Other techniques that can be used to reduce background clutter include a Cell-Averaging Constant False Alarm Rate (CA-CFAR) technique that is known for use in radar processing. For every location cell on a grid, CA-CFAR takes an average of the nearby cells and marks a cell as occupied only if its radar return strength is greater than this average.

In accordance with certain embodiments of the present teachings, receiver sensitivity can be automatically adjusted so that radar pulses are transmitted in sets of four (with receiver sensitivities of 0, −5, −15, and −30 dB) and data from the corresponding rings can be merged into a single scan covering an entire range interval of interest (within, for example, a usable range of the sensor). To merge data into a single scan covering an entire range of interest, a running average of radar readings for each receiver sensitivity value can be maintained, and average returns for current sensitivity settings from current radar readings can be subtracted from the running average of radar readings.

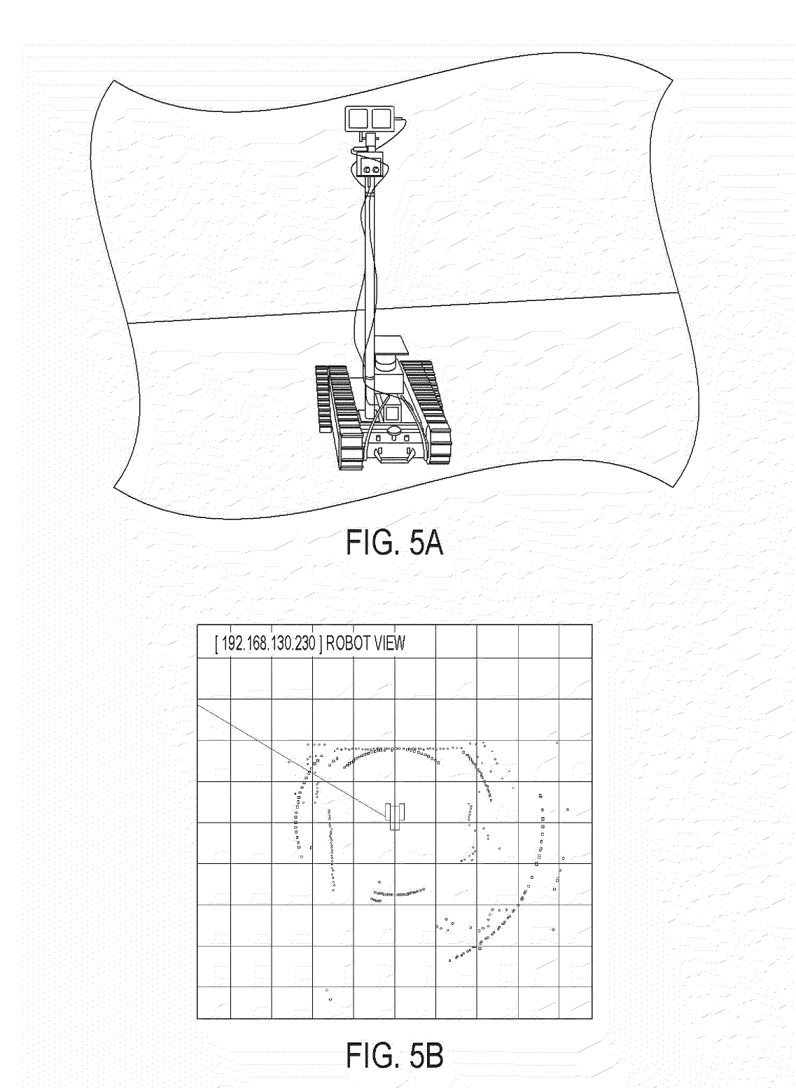

In addition to UWB radar being able to detect objects through obstacles such as fences, dense fog that would completely obscure LIDAR and vision has little or no effect on UWB radar returns. FIGS. 5A, 5B, 6A, 6B, 7A, and 7B illustrate obstacle detection performance of an exemplary UWB radar-equipped remote vehicle in various densities of environmental fog.

FIG. 5A shows an iRobot® PackBot® equipped with UWB radar in an initial, fog-free environment. FIG. 5B shows data from the environment surrounding the iRobot® PackBot®, with UWB radar data being represented by the green (dashed) lines and LIDAR data from the same environment being represented by the red (dotted) lines. Both UWB radar and LIDAR are able to detect the obstacles in the remote vehicle's environment, and the LIDAR shows considerably higher resolution and accuracy. Occupancy grid techniques can be employed in accordance with the present teachings to increase the effective angular resolution of the UWB radar.

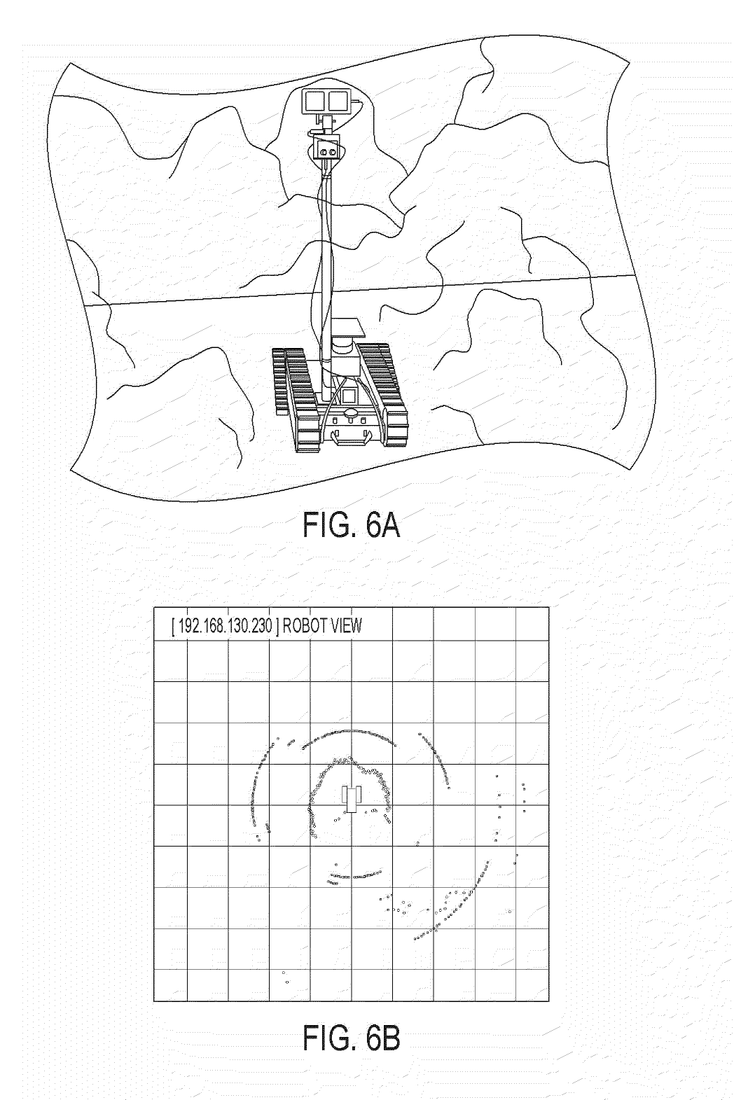

FIG. 6A shows a test environment after a fog machine has been activated to create a moderate density of fog in an environment surrounding the iRobot® PackBot®. FIG. 6B shows exemplary UWB radar and LIDAR returns from the moderate density fog environment of FIG. 6A. In this moderate fog density, LIDAR readings are degraded. In front and to the sides of the remote vehicle, LIDAR can only penetrate the moderate fog density to a depth of about 1 meter. Behind the remote vehicle, the air was sufficiently clear that the LIDAR detected some obstacles. The UWB radar returns in FIG. 6B are virtually identical to those of FIG. 5B, illustrating that the moderate density fog has not affected UWB radar performance.

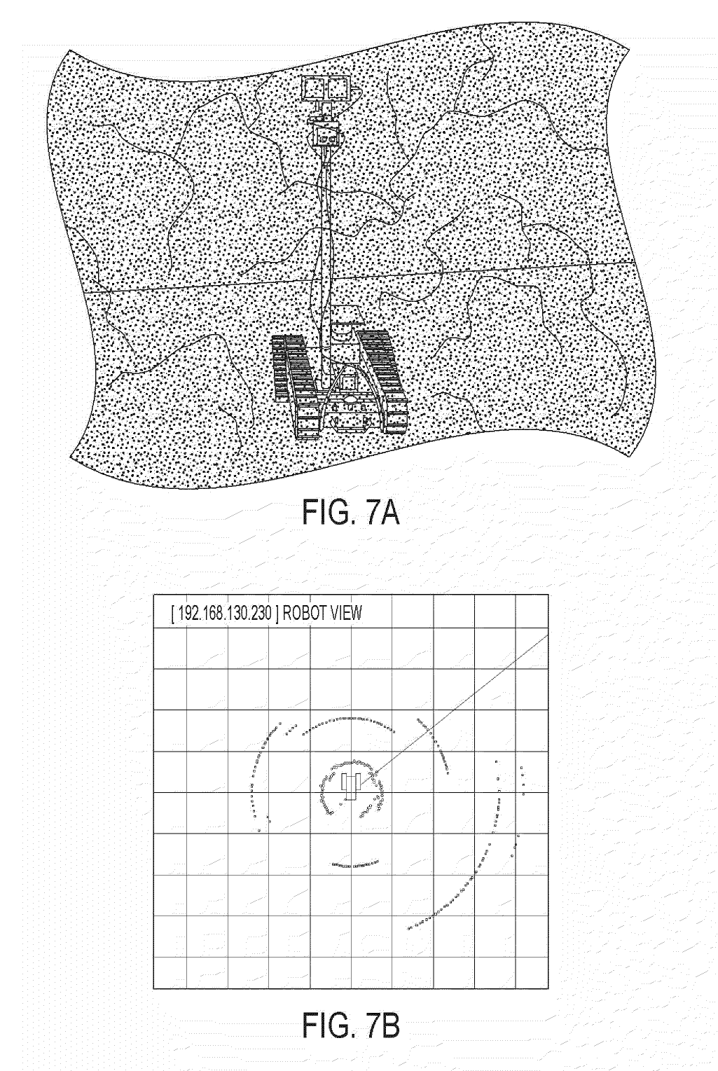

FIG. 7A shows the test environment after it has been completely filled with dense fog. FIG. 7B shows UWB radar and LIDAR returns in from the dense fog environment illustrated in FIG. 7A. The LIDAR can penetrate less than 1 meter through the dense fog of FIG. 7A in all directions, and is incapable of detecting any obstacles beyond this range. The UWB radar readings shown in FIG. 6B are nearly identical to those in FIG. 4B illustrating that the dense fog has not affected UWB radar performance.

In addition to providing UWB radar capability on a remote vehicle, the present teachings also contemplate integrating the UWB radar data with data from other sensors on the remote vehicle, such as LIDAR, stereo vision, GPS/INS/odometer, and sonar. Further, data from one or more of the sensors can be used as input for certain autonomous behaviors that can be performed by the remote vehicle such as, for example, obstacle avoidance, map generation, and waypoint navigation. Algorithms can be utilized to fuse data from the sensors for effective navigation through foliage and poor weather.

In an exemplary embodiment of a remote vehicle with integrated sensors, an iRobot® PackBot® is equipped with a Navigator payload. The Navigator payload typically comprises a 1.8 GHz Pentium 4 processor, a uBlox Antaris 4 GPS receiver, a Microstrain 3DM-GX1 six-axis MEMS IMU, and a LIDAR. An Athena Micro Guidestar can be employed, for example, as an alternative to the Microstrain IMU typically included in the Navigator payload. LIDAR can provide, for example, 360° planar range data at 5 Hz with a resolution of about 2°. The LIDAR can communicate with the Navigator payload's CPU over, for example, a 115 Kbps RS-232 serial interface or an Ethernet link with appropriate driver software. Use of Ethernet communication can significantly increase the available bandwidth, allowing for higher-resolution range scans at higher update rates.

For stereo vision, a stereo camera such as a Tyzx G2 stereo vision module can be integrated, for example with an Athena Micro Guidestar INS/GPS unit, to provide position information for the remote vehicle. The UWB radar can comprise a MSSI RaDeKL ultra wideband sensor. As discussed above, the RaDeKL sensor can be mounted on a TRACLabs Biclops pan/tilt mount, allowing the remote vehicle to accurately scan the UWB radar over a region without moving the remote vehicle.

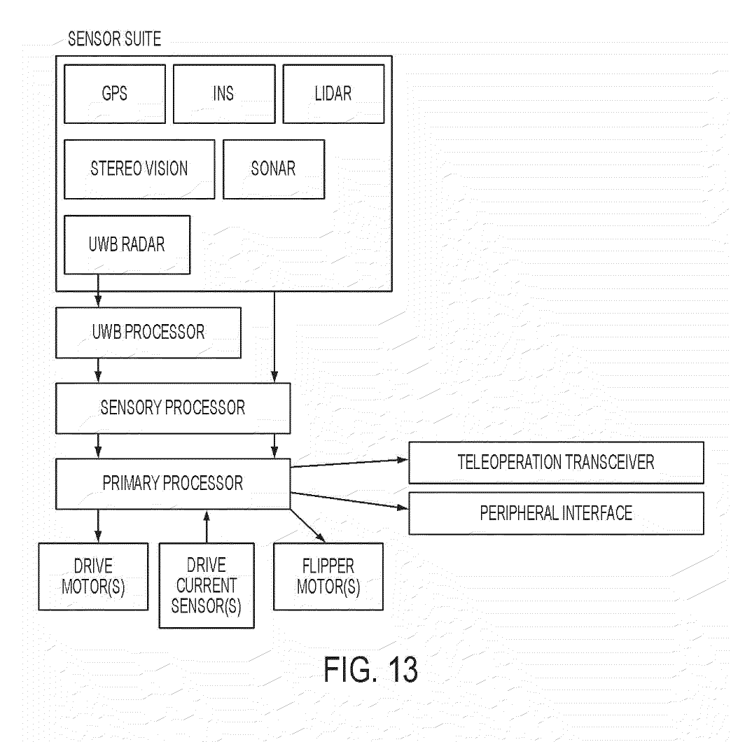

FIG. 13 illustrates an exemplary embodiment of a computer hardware organization for a remote vehicle, in which the remote vehicle's primary processor exchanges data with various peripheral devices via a peripheral interface and arbitrates communication among the peripheral devices. The remote vehicle primary processor can be, for example, an Intel® Pentium-III or Pentium 4 processor. The peripheral interface can be wireless or alternatively may include a USB port into which a USB memory stick may be placed, and onto which the remote vehicle can record data including, for example, a map for manual retrieval by the operator. In this exemplary embodiment, a teleoperation transceiver permits the remote vehicle primary processor to receive commands from an OCU and transmit data, e.g., video streams and map data, to the OCU during operation of the remote vehicle.

A sensor suite including a variety of sensors, as described herein, can provide input to a sensory processor such as the Navigator payload CPU, to facilitate control of the remote vehicle and allow the remote vehicle to perform intended behaviors such as obstacle avoidance and mapping. The sensory processor communicates with the remote vehicle primary processor. A dedicated UWB processor can additionally be provided as needed or desired and can communicate, for example, with the sensory processor.

As illustrated in FIG. 13, the remote vehicle primary processor can also exchange data with the remote vehicle's drive motor(s), drive current sensor(s), and a flipper motor. This data exchange can facilitate, for example, an automatic flipper deployment behavior.

Software for autonomous behaviors to be performed by the remote vehicle, such as mapping and obstacle avoidance behavior software, can run on the remote vehicle primary processor or the sensory processor. The sensory processor can communicate with the remote vehicle primary processor via, for example, Ethernet.

LIDAR can have, for example, a range of 50 meters, a range accuracy of +/−5 cm, an angular resolution of 0.125°, and an update rate of up to 20 Hz. The GPS and INS units can be used to maintain an accurate estimate of the remote vehicle's position. Using a Kalman filter for estimating a gravity vector in combination with a particle filter for localization, certain embodiments of the present teachings provide the ability to estimate the vehicle's position to within about 1 meter to about 2 meters and about 2° to about 3°.

The present teachings also contemplate localization via such methods as, for example, a Monte Carlo Algorithm, a Hybrid Markov Chain Monte Carlo (HMCMC) algorithm, and/or a hybrid compass/odometry localization technique in which a compass is used to determine the remote vehicle's orientation and odometry is used to determine the distance translated between updates. Embodiments of the present teachings contemplate having localization notice when it is having a problem and perform appropriate recovery actions. A limited recovery system can be been implemented to allow the remote vehicle to recover from some errors and interference. One or more algorithms for performing a simple recovery can be integrated into the limited recovery system.

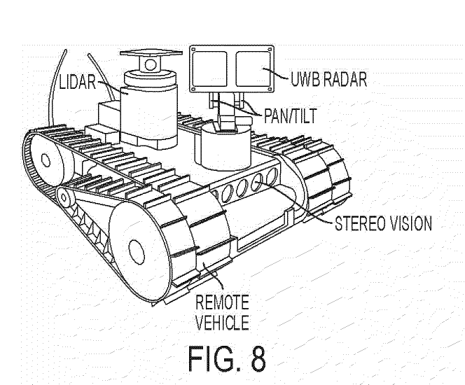

In certain embodiments, UWB radar can be mounted on a pan/tilt as discussed above, and in a configuration without a mast as shown in FIG. 8. The LIDAR can be mounted so that it is does not interfere with, and is not obstructed by, the UWB radar.

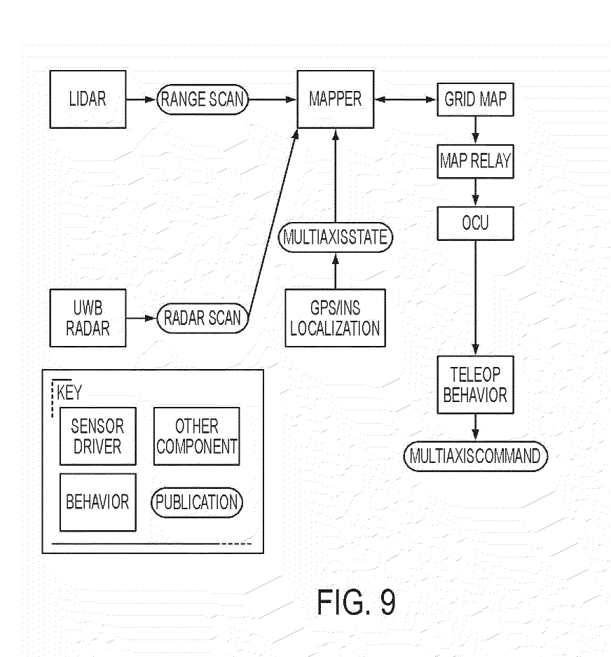

FIG. 9 illustrates an exemplary baseline software design in accordance with the present teachings. The illustrated system allows the user to teleoperate the remote vehicle while building a map using integrated UWB radar and LIDAR. GPS/INS is used for estimating the robot position. The map is relayed back to the OCU for real-time display.

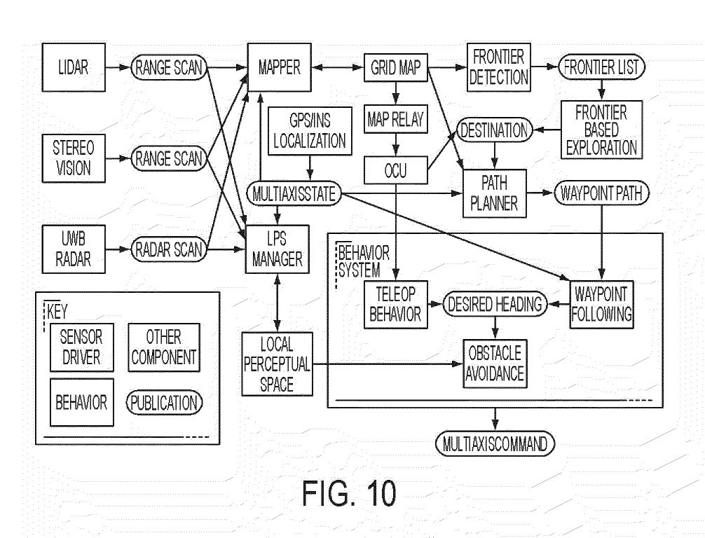

FIG. 10 illustrates an exemplary complete software design in accordance with the present teachings. In this exemplary design, in addition to mapping and teleoperation, the full system can include, for example, obstacle avoidance, waypoint navigation, path planning, and autonomous frontier-based exploration.

The present teachings contemplate integrating a filtered output of the UWB radar with an occupancy grid mapping software, which can reside on, for example, iRobot®'s Aware 2.0 software architecture. The present teachings contemplate data, as perhaps filtered by any of the above-described filters (e.g. delta, radial), being used as a basis for an occupancy grid map. An occupancy grid can be used to combine multiple readings from multiple sensors at multiple locations into a single grid-based representation, where the value of each cell represents the probability that the corresponding location in space is occupied. In accordance with various embodiments of the present teachings, occupancy grids can produce high-accuracy maps from low-resolution UWB radar data, and combine the UWB radar data with typically high-resolution LIDAR data and stereo vision data.

The occupancy grid mapping software can continuously add new obstacle locations (as determined by the current data (which may be filtered)) to the map as the remote vehicle moves through the world. The occupancy grid mapping software may or may not remove old obstacles from the map.

In accordance with various embodiments, the UWB radar can be used in one of two modes. In scanning mode, the UWB radar is continuously panned through a near-360° arc. In fixed mode, the radar is positioned at a fixed orientation relative to the remote vehicle and the remote vehicle's motion is used to sweep the UWB radar. For example, the UWB radar can be positioned to look to a side of the remote vehicle, and the remote vehicle can move forward to sweep the sensor across its environment. The scanning mode is advantageous because the occupancy grid mapping software can receive UWB radar reflections from all directions. However, in a scanning mode the UWB radar can require approximately 4 seconds to complete a one-way 360° scan, so the remote vehicle must move slowly to prevent gaps in the map. In a non-scanning mode, the remote vehicle can move faster without creating gaps in UWB radar coverage. However, a non-scanning side-facing UWB radar may not provide suitable data for obstacle avoidance. A non-scanning front-facing UWB radar may be suitable for obstacle avoidance but not for mapping.

Occupancy grids can rely on statistical sensor models (e.g., based on Bayesian probability) to update the corresponding cell probabilities for each input sensor reading. For example, since LIDAR is very precise, a single LIDAR reading could increase the probability of the corresponding target cell to near 100% while reducing the probability of the cells between the LIDAR and the target to nearly 0%. In contrast, sonar readings tend to be imprecise, so a single sonar reading could increase the probability for all cells along an arc of the sonar cone, while reducing the probability for all cells within the cone—but not with the high confidence of a LIDAR sensor model. The present invention contemplates developing and applying a Bayesian sensor model suitable for the precision expected from UWB radar.

In accordance with certain embodiments, the present teachings contemplate utilizing two separate occupancy grids: one for solid objects and one for foliage. The value of each cell in the solid-object grid will represent the probability that the corresponding location is occupied by a solid object. The value of each cell in the foliage grid will represent the probability that the corresponding location is occupied by foliage.

Certain embodiment of the present teachings utilize approaches for a UWB radar sensor model that are similar to that commonly used in synthetic aperture radar (SAR). For each radar return, each radar bin corresponds to a region along a curved surface at the corresponding range from the sensor. The occupancy probability that all cells on the curved surface are increased in proportion to the value of the range bin. Over time, as data is collected from different radar positions and orientations, obstacles can be resolved in greater detail.

The present teachings contemplate generating two-dimensional grids and/or three-dimensional grids to provide more information about the remote vehicle's environment, and to aid in distinguishing reflections from the ground plane from reflections from other objects. The present teachings also contemplate constructing 3D occupancy grid maps, for example using the sensory processor, preferably in real time.

In accordance with various embodiments of the present teachings, UWB radar data can be used as input to certain autonomous behaviors supported by the remote vehicle such as, for example, an obstacle avoidance behavior. For each UWB radar return, an above-described filter (e.g., radial or delta) can be applied, and the filtered UWB radar data can be thresholded. For the bins that exceed the threshold, a point at a corresponding location can be added to a UWB radar point cloud. The radar point cloud can then be passed to the autonomous behavior (e.g., the obstacle avoidance behavior) or can be combined with other data and then passed to the obstacle avoidance behavior.

Regarding employment of an obstacle avoidance behavior, the present teachings contemplate allowing an operator to select among the following modes: (1) obstacle avoidance off; (2) obstacle avoidance on with input only from LIDAR; (3) obstacle avoidance on with input only from UWB radar; and (4) obstacle avoidance on with input from both LIDAR and UWB radar. In mode (4), for example, the obstacle avoidance behavior can use point clouds from both a LIDAR driver and a filtered, thresholded UWB radar data to control the remote vehicle's motion.

The following is an exemplary, simplified method for implementing a UWB radar-based obstacle avoidance behavior using MFA-filtered data as input. It should be noted that a target heading generated by one or more navigation behaviors (e.g., follow-street or follow-perimeter) can initially be passed to the obstacle avoidance behavior, which may modify the target heading in response to an obstacle detected along the target heading. Alternatively, the heading can be provided via a teleoperation command. At the start, the UWB radar is aimed directly forward relative to the remote vehicle's current heading. Next, the remote vehicle moves forward at a specified speed as long as a distance returned by the MFA is below a specified minimum clearance threshold. Next, if the distance returned by the MFA is below the specified minimum clearance threshold, pan the UWB radar right to left across a full 360° range of the UWB radar pan axis, and continue until the range returned by the MFA exceeds the minimum clearance threshold. Next, the UWB radar stops panning and is pointed in the direction in which the clearance exceeds the minimum limit and the angle in which the UWB radar is pointing is stored. Finally, the remote vehicle is turned to face the stored angle and begins again at the initial step above.

Certain embodiments of the present teachings can utilize a Scaled Vector Field Histogram SVFH type of obstacle avoidance behavior, which is an extension of the Vector Field Histogram (VFH) techniques developed by Borenstein and Koren, as described in Borenstein et al., The Vector Field Histogram—Fast Obstacle Avoidance for Mobile Robots,” IEEE Journal of Robotics and Automation, Vol. 7, No. 3, June 1991, pp. 278-88, the content of which is incorporated herein in its entirety.

In the Borenstein's VFH technique, an occupancy grid is created and a polar histogram of the obstacle locations is created relative to the remote vehicle's current location. Individual occupancy cells are mapped to a corresponding wedge or “sector” of space in the polar histogram. Each sector corresponds to a histogram bin, and the value for each bin is equal to the sum of all the occupancy grid cell values within the sector.

A bin value threshold is used to determine whether a bearing corresponding to a specific bin is open or blocked. If the bin value is under the bin value threshold, the corresponding direction is considered clear. If the bin value meets or exceeds the bin value threshold, the corresponding direction is considered blocked. Once the VFH has determined which headings are open and which are blocked, the remote vehicle can pick a heading closest to its desired heading toward its target/waypoint and move in that direction.

The Scaled Vector Field Histogram (SVFH) is similar to the VFH, except that the occupancy values are spread across neighboring bins. Since the remote vehicle is not a point object, an obstacle that may be easily avoided at long range may require more drastic avoidance maneuvers at short range, and this is reflected in the bin values of the SVFH. The extent of the spread can be given by θ=k/r, where k is a spread factor (for example, 0.4 in the current SVFH), r is a range reading, and θ is a spread angle in radians. For example: if k=0.4 and r=1 meter, then the spread angle is 0.4 radians (23°). So a range reading at 1 meter for a bearing of 45° will increment the bins from 45−23=22° to 45+23=68°. For a range reading of 0.5°, the spread angle would be 0.8 radians (46°), so a range reading at 0.5 meters will increment the bins from 45−46=−1° to 45+46=91°. In this way, the SVFH causes the robot to turn more sharply to avoid nearby obstacles than to avoid more distant obstacles.

In certain embodiments, a set of heuristic rules can be used to classify grid cells as obstacles based on the properties of the remote vehicle system. The heuristic rules can include, for example: (1) a grid-to-grid slope threshold applied to detect obstacles too steep for the remote vehicle to climb (e.g., surfaces that appear to change at a slope >45° can be classified as obstacles if they are insurmountable by the remote vehicle; (2) a grid minimum height threshold applied to detect and classify overhanging obstacles that don't touch the ground yet still may obstruct the remote vehicle (e.g., a high truck body may not be classified as a true obstacle if the remote vehicle can pass under the truck).

In certain embodiments, the obstacle avoidance behavior can receive data regarding an obstacle detected and uses the data to determine dimensions of the obstacle. To ensure proper clearance, the obstacle avoidance behavior can bloat the obstacle by a pre-determined value so that an avoidance vector can be calculated. The avoidance vector allows the remote vehicle to drive along a path that avoids the obstacle. As the remote vehicle drives forward, the routine continues to check for obstacles. If another obstacle is detected, the remote vehicle data regarding the obstacle and determines its dimensions, bloats the obstacle and calculates a new avoidance vector. These steps can occur until no obstacle is detected, at which point the obstacle avoidance routine can be exited and the remote vehicle can continue on its path or calculate a proper return to its path.

In certain embodiments, the obstacle avoidance behavior can include a memory of nearby obstacles that persists even when the obstacles cannot be seen. The memory can be represented as an occupancy grid map that is roughly centered on the remote vehicle.

In the image generated by the sensors used for obstacle detection, each pixel has a depth value (or no value if not available). Availability of a depth value depends on the sensor type. For example, LIDAR may not return a depth value for black or mirrored surfaces, and a stereo vision camera may not return a depth value for a surface without texture. Data from more than one type of sensor can be used to maximize the pixels for which depth values are available.

The direction of each pixel can be determined based on the field of view of a particular sensor and its pan angle. Thus, the direction and depth of each pixel is known and a two-dimensional image of a predetermined size is created, each cell in the two-dimensional image including a depth to the nearest detected potential obstacle. A vertical column in the two-dimensional image corresponds to a vertical slice of the sensor's field of view. Points are plotted for each column of the two-dimensional image output from the sensor, the plotted points representing a distance from the remote vehicle and a height. From the plotted points, one or more best-fit lines can be created by sampling a predetermined number of sequential points. In certain embodiments, a best-fit line can be created for, for example, 15 sequential points, incrementing the 15-point range one point at a time. The best-fit line can be determined using a least squares regression or a least squares minimization of distance from fit line to data points.

Once one or more best-fit lines have been determined, the slope of each line can be compared to a predetermined threshold slope. If the slope of the best-fit line is greater than the predetermined threshold slope, the best-fit line can be classified as an insurmountable obstacle. The predetermined threshold slope can depend, for example, on the capabilities of the remote vehicle and/or on certain other physical characteristics of the remote vehicle (e.g., its pose or tilt) that determine whether the remote vehicle can traverse an obstacle having a given slope. Using this method, every column in the two-dimensional image is translated into a single value representing a distance to the closest obstacle. Thus the two-dimensional pixel grid is transformed into a single row of values or bins. The distance may be infinity when no obstacle is detected. Slope measurement can be used to filter out the ground.

In certain embodiment, the single row of values or bins can be downsampled to a desired number of bins. While a greater number of bins provides a finer resolution for determining obstacle position, a lesser number of bins simplifies subsequent processing. The downsampled bins can be utilized as input to the obstacle avoidance software. Indeed, downsampling may be necessary or desirable when a sensor's data is more robust than the obstacle avoidance software is designed to handle.

The bins containing obstacle distances can used to create the occupancy grid representing the remote vehicle within its environment. The occupancy grid can be updated periodically to add the remote vehicle's location and the location of detected obstacles. When an obstacle is detected within a cell during a scan, the bin is incremented. Based on distances to obstacles, an obstacle-free area is detected. In certain embodiments, every cell in the obstacle-free area can be decremented to provide more robust obstacle detection data.

As the remote vehicle's location is updated, for example via GPS or odometry, so is its position within the occupancy grid. Updates to the remote vehicle's position and the position of obstacles can be performed independently and consecutively.

In various embodiments, more recent information can be weighted to represent its greater importance. An exponential average, for example, can be used to properly weight new information over old information. Exponential averaging is computationally efficient and can handle moving object detection suitably well. The weight afforded newer information can vary, with current values in the grid being made to decay exponentially over time. In certain embodiments, a negative value (indicating no obstacle) can be made to switch to a positive value (indicating the existence of an obstacle) within three frames. Noise from the sensor should be balanced with accuracy in weighting and decaying values within the grid.

As the remote vehicle moves, parts of the local memory that are far from the remote vehicle can be forgotten and new areas can be added near the remote vehicle. The grid can remain fixed in the environment and the remote vehicle's location within the fixed grid can be tracked as it moves and the grid wraps around in both directions as necessary to keep the remote vehicle roughly centered. This can be accomplished using a modulus on the index. In computing, the modulo operation finds the remainder of division of one number by another. Given two numbers, a (the dividend) and n (the divisor), a modulo n (abbreviated as a mod n) is the remainder, on division of a by n. For instance, the expression “7 mod 3” would evaluate to 1, while “9 mod 3” would evaluate to 0. Practically speaking for this application, using a modulus causes the program to wrap around to the beginning of the grid if locations of the remote vehicle or detected obstacles go past a grid end point.

As the remote vehicle's location crosses a cell boundary within the occupancy grid, data opposite the remote vehicle can be cleared so that those cells are available to receive new data. However, despite clearing data opposite the remote vehicle, some detected obstacle data beside and behind the remote vehicle continues to be updated—if sensor data is available—and is available if needed until cleared.

In certain embodiments, local perceptual space (LPS) can be utilized to store a representation of obstacles in the immediate vicinity of the remote vehicle via data from, for example, UWB radar, LIDAR, and stereo vision. An LPS is a local map in remote vehicle-centric coordinates that is centered at the remote vehicle's current location. The LPS can be stored as an occupancy grid and can cover, for example, a 4 meter×4 meter area with 0.12 meter×0.12 meter cells. Each grid cell stores a weighted sum of evidence for/against an obstacle in that grid cell. Points decay from the LPS over time to minimize accumulation of any position error due to remote vehicle motion. Typically, an LPS will represent the obstacles detected over the previous 5-30 seconds.

As stated above, the grid can remain centered on the remote vehicle and can be oriented in a fixed direction that is aligned with the axes of odometric coordinates (a fixed coordinate frame in which the remote vehicle's position is updated based on odometry). The remote vehicle's current position and orientation in odometric coordinates can also be stored. Each grid cell can cover a range of odometric coordinates. The exact coordinates covered may not be fixed, however, and can change occasionally as the robot moves. The grid can thus act like a window into the world in the vicinity of the remote vehicle. Everything beyond the grid edges can be treated as unknown. As the remote vehicle moves, the area covered by the grid also moves. The position of the remote vehicle has an associated grid cell that the remote vehicle is currently inside. The grid cell associated with the remote vehicle acts as the center of the LPS. The grid is wrapped around in both x and y directions (giving the grid a toroidal topology) to provide a space of grid cells that moves with the remote vehicle (when the remote vehicle crosses a cell boundary) and stays centered on the remote vehicle. Cells directly opposite from the position of the remote vehicle in this grid can be ambiguous as to which direction from the robot they represent. These cells are actively cleared to erase old information and can be dormant until they are no longer directly opposite from the remote vehicle. This embodiment can provide a fast, efficient, and constant memory space.

To use LPS in certain autonomous remote vehicle behaviors, a virtual range scan can be computed to the nearest obstacles. The virtual range scan can represent what a range scanner would return based on the contents of the LPS. Converting to this form can allow behaviors to use data that originates from a variety of sensors.

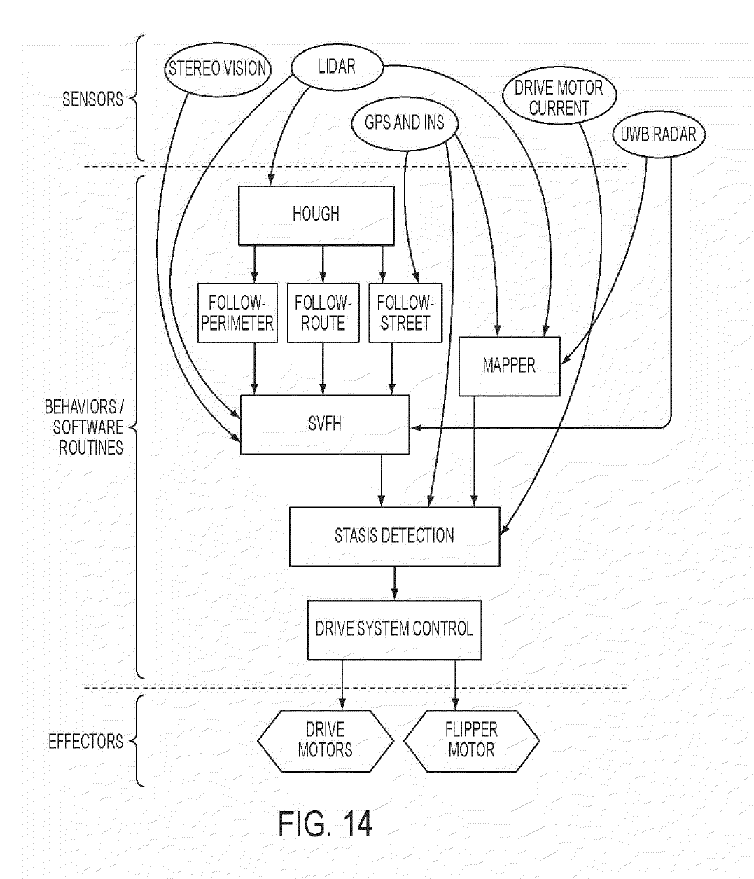

FIG. 14 illustrates an exemplary embodiment of a data flow among system components segregated into functional groups. At the top of FIG. 14, various sensors available on the remote vehicle, such as UWB radar, LIDAR, stereo vision, GPS, and/or INS supply information to behaviors and routines that can execute on the remote vehicle's primary processor. The drive motor current sensor, which may include an ammeter on the remote vehicle's chassis for example, can supply appropriate information to a stasis detector. A stasis detector routine can utilize such information, for example, to deploy the flippers automatically when a drive motor current indicates collision with an obstacle.

Because UWB radar can have a limited field of view (40°) and angular resolution (also 40°), the UWB radar data can be coarse and limited to a portion of the possible directions of travel of a host remote vehicle. For this reason, certain embodiments of the present teachings accumulate UWB radar returns over time, both to remember obstacles that the remote vehicle is not currently facing, and also to increase the precision of obstacle detection using UWB radar data and, for example, Bayesian sensor models as noted above.

SVFH obstacle avoidance (and other obstacle avoidance behaviors) can use LPS in the same way that it uses direct or filtered sensor data. SVFH obstacle avoidance can add the number of LPS points that are within each polar coordinate wedge to a total for a corresponding angular bin. Bins that are below a threshold value are treated as open, and bins that are above a threshold value are treated as blocked. In addition, each LPS point can have an associated confidence value that weights the contribution of that point to the corresponding bin. This confidence value can be based on time, weighing more recent points more heavily, and can additionally or alternatively be modified by other sensor data (e.g., UWB radar data). An example of modifying the confidence value based on UWB radar data follows.

UWB radar data can be filtered and then thresholded to determine which range bins have significant returns that may indicate a potential obstacle. Clear ranges can then be computed for the filtered UWB data returns. The clear range is the maximum range for which all closer range bins are below threshold. If all of the range bins are below threshold, then the clear range is equal to the maximum effective range of the UWB radar. To compensate for the large constant returns that can be observed at very close ranges, certain embodiment of the present teachings can determine a minimum sensor range R_{MIN} and discard returns that are closer than R_{MIN}. Adaptive transmitter/receiver attenuation can additionally or alternatively be used to optimize R_{MIN} for the current environment.

Confidence for LPS obstacle points can then be reduced in a wedge of space corresponding to the UWB radar field of view (e.g., 40°) starting at a minimum range of the UWB radar and extending over the cleared range R_{C}, on the assumption that if the UWB radar does not detect any obstacle in this region, any returns from LIDAR or stereo vision are likely spurious (e.g., returns from falling snow, rain, or dust). If this assumption occasionally turns out to be false, the LIDAR and/or stereo vision can still detect the obstacles if they get closer than the minimum UWB radar range.

To deal with foliage, the present teachings contemplate further reducing the confidence of LPS obstacle points in the wedge of space corresponding to the UWB radar field of view, starting at R_{MIN} and extending over the cleared range R_{C}. This is based on the assumption that range bins that are below threshold in the UWB radar returns correspond to space that is either clear or occupied only by foliage. As above, if this assumption is sometimes false, the remote vehicle can still see the obstacle eventually with LIDAR and stereo vision if the obstacle gets closer than the minimum UWB radar range. In accordance with certain embodiments, reduction of confidence based on foliage can occur only when a “foliage mode” is selected based, for example, on a mission or environment.

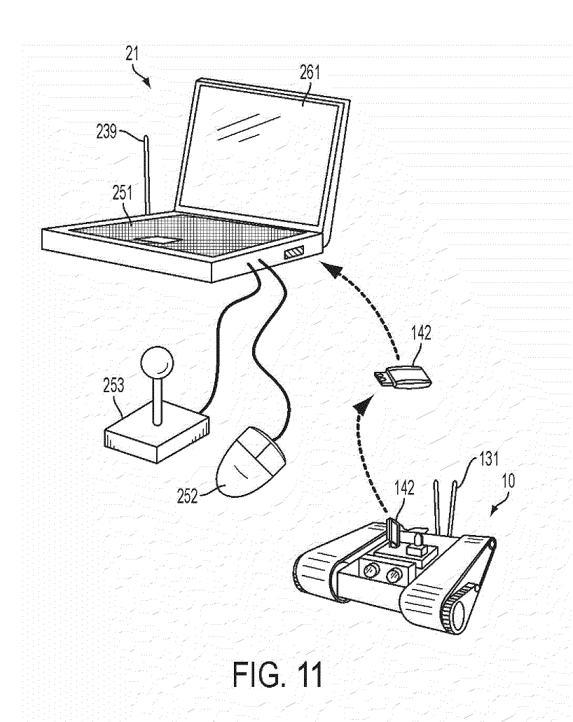

FIG. 11 illustrates an exemplary embodiment of an operator control unit (OCU) 21 for controlling a remote vehicle in accordance with the present teachings. An OCU used in accordance with the present teachings preferably has standard interfaces for networking, display, wireless communication, etc. The OCU 21 can include a computer system (e.g., a laptop) having a display 261 for presenting relevant control information including, for example, an occupancy grid map to the operator, as well as input systems such as a keyboard 251, a mouse 252, and a joystick 253. The control information can be transmitted wirelessly from an antenna 131 of the remote vehicle 10 to an antenna 239 of the OCU 21. Alternatively, the remote vehicle 10 may store control information such as the occupancy grid map on a detachable memory storage device 142 (which may be a USB memory stick, a Flash RAM or SD/MMC memory chip, etc.) that the operator can retrieve when the remote vehicle completes an autonomous operation and access using the OCU 21 or another suitable device.

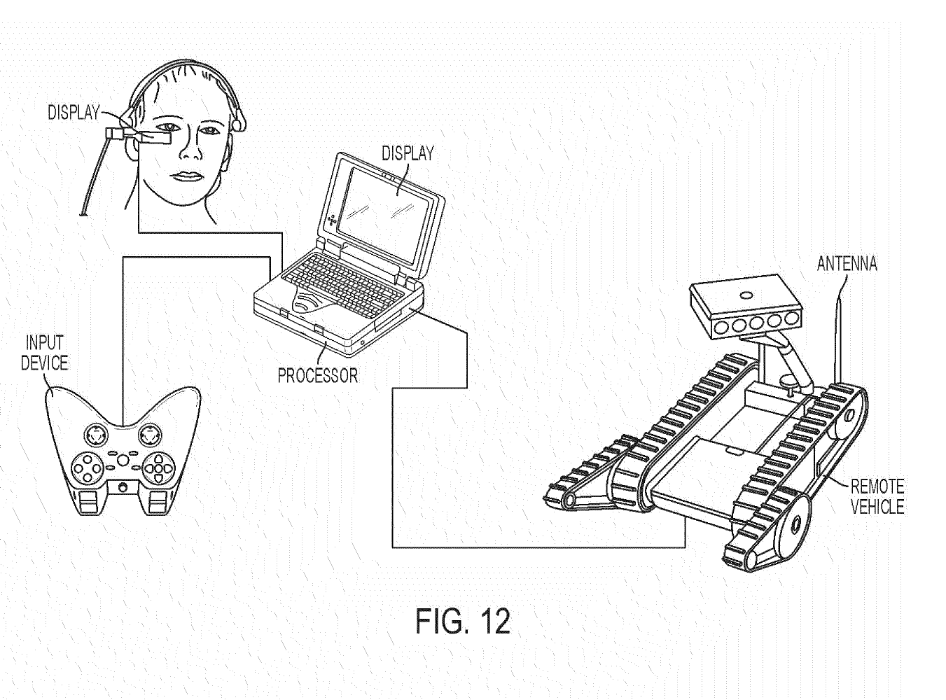

FIG. 12 illustrates another exemplary embodiment of an OCU for use with the present teachings. Basic components include a display, a keyboard, an input device (other than the keyboard) such as a hand-held controller, a processor, and an antenna/radio (for wireless communication). In certain embodiments, a head-mounted display can provide additional and/or alternative data to the operator, such as video display from one or more remote vehicle cameras. The hand-held controller, preferably having a twin-grip design, includes controls to drive and manipulate the remote vehicle and its payloads. Audio may additionally be provided via the hand-held controller, the display, or a dedicated listening device such as, for example, a Bluetooth headset commonly used with mobile phones. A microphone can be provided on the hand-held controller, the processor, the display, or separately from these components, and can be used with a speaker on the remote vehicle to broadcast messages. A button on the hand-held controller or a soft button within the GUI can be used to activate the speaker and microphone for broadcasting a message.

The OCU embodiment illustrated in FIG. 12 can include a processor such as a rugged laptop computer. The processor could alternatively be any suitably powerful processor including, for example, a tablet PC such as an HP TC1100 running a SuSe 9.2 Linux operating system and 802.11 wireless capability and graphics with direct rendering and a touch-screen interface such as a stylus interface. In certain embodiments of the present teachings, the processor can be mounted to the forearm of a user, freeing up both of the user's hands to perform teleoperation or other tasks. A tablet PC embodiment provides an effective hardware platform due to its small form factor, light weight, and ease of use due to a touch-screen interface. It allows the operator to remain mobile and maintain a degree of situational awareness due to the simple and intuitive interface. To maximize the utility of a touch screen-based platform, use can be made of layered windows to provide a desired level of information display for the operator's current situation, as well as clickable toolbars designating the current mode of interaction for the stylus or other touch screen indicator (e.g., the operator's fingers).

The processor can communicate with the remote vehicle wirelessly or via a tether (e.g., a fiber optic cable). Although wireless communication may be preferable in some situations of remote vehicle use, potential for jamming and blocking wireless communications makes it preferable that the control system be adaptable to different communications solutions, in some cases determined by the end user at the time of use. A variety of radio frequencies (e.g., 802.11), optical fiber, and other types of tether may be used to provide communication between the processor and the remote vehicle.

The processor additionally communicates with the hand-held controller and the display. In certain embodiments of the present teachings, the processor is capable of communicating with the hand-held controller and the display either wirelessly or using a tether. To facilitate wireless communication among the various elements of the system, the OCU can include a radio and an antenna.

The processor can include software capable of facilitating communication among the system elements and controlling the remote vehicle. In certain embodiments of the present teachings, the software is a proprietary software and architecture, such as iRobot®'s Aware®2.0 software, including a behavioral system and common OCU software, which provide a collection of software frameworks that are integrated to form a basis for robotics development.

In accordance with certain embodiments, this software is built on a collection of base tools and the component framework, which provide a common foundation of domain-independent APIs and methods for creating interfaces, building encapsulated, reusable software components, process/module communications, execution monitoring, debugging, dynamic configuration and reconfiguration as well as operating system insulation and other low-level software foundations like instrument models, widget libraries, and networking code.

In various embodiments, the remote vehicle primary processor can use data from the OCU to control one or more behaviors of the remote vehicle. The commands from the operator can include three levels of control as applicable based on the autonomy capabilities of the remote vehicle: (1) low-level teleoperation commands where the remote vehicle need not perform any autonomous behaviors; (2) intermediate level commands including a directed command in the remote vehicle's local area, along with an autonomous behavior such as obstacle avoidance; and (3) high-level tasking requiring the remote vehicle to perform a complimentary autonomous behavior such as path planning.

In certain embodiments, the software components used in controlling the remote vehicle can be divided among two or more processors. The OCU can, for example, have a processor and display information and send commands to the remote vehicle, performing no significant computation or decision making, except during map generation. The remote vehicle can have two processors—a sensory processor (see FIG. 13) and a primary processor (see FIG. 13)—and computation can be divided among these two processors with data (e.g., computation results, etc.) being passed back and forth as appropriate.

The primary software components can include a sensor processing server, a localization server, a video compression server, an obstacle avoidance server, a local perceptual space server, a low-level motor control server, a path planning server, and other behavior-specific servers as appropriate. The present teachings contemplate the software components or servers having individual functionality as set forth in the above list, or combined functionality. The sensor processing server handles communication with each sensor and converts data output from each sensor, as needed.

In certain embodiments, the localization server can use, for example, range data derived from LIDAR stereo vision, map data from a file, and odometry data to estimate the remote vehicle's position. Odometry broadly refers to position estimation during vehicle navigation. Odometry also refers to the distance traveled by a wheeled vehicle. Odometry can be used by remote vehicles to estimate their position relative to a starting location, and includes the use of data from the rotation of wheels or tracks to estimate change in position over time. In an embodiment of the invention, the localization server can run on the sensory processor (see FIG. 13), along with a video compression server that receives input from stereo vision. Video compression and encoding can, for example, be achieved via an open-source ffmpeg video compression library and the data is transmitted via User Datagram Protocol (UDP), an internet protocol.

In various embodiment, a behavior-specific and low-level motor control server run on the remote vehicle's primary processor (see FIG. 13). Additional software components may include an OCU graphical user interface, used for interaction between the operator and the remote vehicle, and a mapping component that generates maps from sensor data. In certain embodiments, these additional software components can run on the OCU processor.

The present teachings also contemplate using UWB technology for looking through wall. Because UWB has the capability to see through wall, a remote vehicle equipped with such capability can be driven up to a wall and used to provide an image including a certain amount of information regarding what is on the other side of that wall, as would be understood by those skilled in the art. The present teachings also contemplate using a remote vehicle having appropriate sensors and software to perform, for example, perimeter tracking and/or street traversal reconnaissance in autonomous or semi-autonomous operation, while avoiding obstacles.

In certain embodiments of the present teachings, a sonar sensor can be used to detect obstacles such as glass and/or narrow metal wires, which are not readily detected by other sensory devices. A combination of UWB radar, LIDAR range finding, stereo vision, and sonar, for example, can provide the capability to detect virtually all of the obstacles a remote vehicle might encounter in an urban environment.

Also, in certain embodiments of the present teachings wherein the UWB radar requires a separate operating system (e.g., Windows as opposed to Linux), a separate UWB processor can be provided (see FIG. 13) to process UWB radar data. In an embodiment of the invention, the UWB processor can configure the UWB radar, receive UWB radar data, and transmit the UWB radar data to, for example, a sensory processor and/or a primary processor.

In certain exemplary embodiments of the present teachings, a filter can be used to address instances where the remote vehicle becomes tilted and sensor planes intersect the ground, generating “false positive” (spurious) potential lines that could confuse navigation behaviors. The filter can use data from a pan/tilt sensor to project sensor data points into 3D, and the points in 3D that are located below the robot (relative to the gravity vector) are removed from the sensor data before the sensor data is passed to, for example, the Hough transform. When the remote vehicle is tilted, the sensor plane can intersect the ground at one or more point below the remote vehicle, and these points will have a negative Z-coordinate value relative to the remote vehicle. In simple urban terrain, the remote vehicle can just ignore these points. In more complex terrain, the remote vehicle can, for example, be instructed to explicitly avoid these points.

Other embodiments of the present teachings will be apparent to those skilled in the art from consideration of the specification and practice of the teachings disclosed herein. It is intended that the specification and examples be considered as exemplary only, with a true scope and spirit of the invention being indicated by the following claims.

What is claimed is:

1. A system for controlling a remote vehicle, the system comprising:
a LIDAR sensor, a stereo vision camera, and a UWB radar sensor;
a sensory processor configured to process data from one or more of the LIDAR sensor, the stereo vision camera, and the UWB radar sensor; and
a remote vehicle primary processor configured to receive data from the sensory processor and utilize the data to perform an obstacle avoidance behavior.

2. The system of claim 1, further comprising a UWB radar processor configured to process data from the UWB radar sensor.

3. The system of claim 2, wherein the UWB radar processor sends data from the UWB radar sensor to the sensory processor.

4. The system of claim 2, wherein the UWB radar processor sends data from the UWB radar sensor to the remote vehicle primary processor.

5. The system of claim 1, further comprising a GPS and an IMU, the sensory processor being configured to receive data from the GPS and the IMU.

6. The system of claim 1, wherein data from the LIDAR sensor and the UWB radar sensor is integrated and utilized by the remote vehicle process to perform an obstacle avoidance behavior.

7. The system of claim 6, wherein the integrated LIDAR sensor and UWB radar sensor data is stored in an occupancy grid map.

8. The system of claim 1, wherein local perceptual space stores a representation of obstacles in the immediate vicinity of the remote vehicle via data from the LIDAR sensor and the UWB radar sensor.

9. A system for allowing a remote vehicle to discern solid impassable objects from rain, snow, fog, and smoke for the purposes of performing an obstacle avoidance behavior, the system comprising:
a LIDAR sensor, a stereo vision camera, a UWB radar sensor, and a GPS;
a sensory processor configured to process data from one or more of the LIDAR sensor, the stereo vision camera, the UWB radar sensor, and the GPS; and
a remote vehicle primary processor configured to receive data from the sensory processor and utilize the data to perform the obstacle avoidance behavior,
wherein data from the UWB radar sensor is integrated with data from the LIDAR sensor to yield data for the obstacle avoidance behavior that represents solid impassable objects rather than rain, snow, fog, and smoke.

10. The system of claim 9, further comprising a UWB radar processor configured to process data from the UWB radar sensor.

11. The system of claim 10, wherein the UWB radar processor sends data from the UWB radar sensor to the sensory processor.

13. The system of claim 10, wherein the UWB radar processor sends data from the UWB radar sensor to the remote vehicle primary processor.

14. The system of claim 9, wherein the integrated LIDAR sensor and UWB radar sensor data is stored in an occupancy grid map.

15. The system of claim 9, wherein local perceptual space stores a representation of impassable obstacles in the immediate vicinity of the remote vehicle via data from the LIDAR sensor and the UWB radar sensor.

16. A method for allowing a remote vehicle to discern solid impassable objects from rain, snow, fog, and smoke for the purposes of performing an obstacle avoidance behavior, the method comprising:
integrating data from a LIDAR sensor with data from a UWB radar sensor to yield data for the obstacle avoidance behavior that represents solid impassable objects rather than rain, snow, fog, and smoke.

17. The method of claim 16, further comprising filtering the data from the UWB radar sensor to remove ground clutter.

18. The method of claim 16, further comprising storing the integrated data in an occupancy grid map.

19. The method of claim 16, further comprising storing a representation of the integrated data in local perceptual space.

20. The method of claim 16, further comprising using data from the UWB radar sensor to provide data regarding objects that are not detectable via LIDAR data or stereo vision data.
